(19) United States
(12) Patent Application Publication
(10) Pub. No.: US 2007/0171867 A1
(43) Pub. Date: Jul. 26, 2007

(54) System and method for setting handover based on quality of service in wcdma system

(75) Inventor: Young-lak Kim, Gyeonggi-do (KR)

Correspondence Address: LAHIVE & COCKFIELD, LLP, ONE POST OFFICE SQUARE, BOSTON, MA, 02109-2127, US

(73) Assignee: SK Telecom Co., Ltd., JUNG-GU (KR)

(21) Appl. No.: 10/556,869

(22) PCT Filed: May 14, 2004
(86) PCT No.: PCT/KR04/01140

§ 371 Date: Jan. 11, 2007

(30) Foreign Application Priority Data
May 14, 2003 (KR) 10-2003-0030617

(51) Int. Cl. H04Q 7/00

(52) U.S. Cl. 370/331

(57) ABSTRACT

The present invention relates to a method and system for performing handover based on a degree of QoS in WCDMA system. The method and system in accordance with the present invention establishes a new wireless link for use in hard handover upon determining the degree of QoS of a mobile communication terminal, transmits a wireless link establishment request message to a new base station so as to establish a data transmission path to the new base station, transmits an active-set update command message to perform the hard handover, and finally release a data transmission path with a home base station.

### TECHNICAL FIELD

The present invention relates to a method and system for establishing a handover based on a QoS (Quality of Service) of a WCDMA (Wideband Code Division Multiple Access) system, and more particularly to a method and system for establishing a handover based on a QoS of a WCDMA system, which performs a hard handover to a call signal having a low QoS when determining a handover scheme according to a QoS grade in the WCDMA system, resulting in minimum waste of channel resources.

### BACKGROUND ART

Typically, a WCDMA communication scheme is an asynchronous wireless protocol recommended by IMT (International Mobile Telecommunication)—2000, as suitable for transmission of a large amount of data since it uses a Spread-Spectrum scheme, and provides subscribers or users with very superior communication quality. The WCDMA communication scheme adapts 32 kbps ADPCM (Adaptive Differential Pulse Code Modulation), and provides even a user who moves from a present location to another location at a specific speed of about 100 km/h with high mobility capable of guaranteeing a sufficient speech quality.

A WCDMA system based on the WCDMA communication scheme allows either a single BTS (Base Transceiver Station) or a BTS System Controller (BSC) to include a hardware module for a circuit mode and a hardware module for a packet mode, such that the BTS or the BSC is independently operated in the circuit mode and the packet mode. In other words, a BTS transmitter for use in the BTS includes a first channel card for the circuit mode and a second channel card for the packet mode, and the BSC includes a data processing board for processing data transmitted/received in the packet mode and a signal processing board for processing a voice or audio signal transmitted/received in the circuit mode. Therefore, if a mobile communication system such as the BTS or BSC transmits multimedia data to a mobile station (MS) (also called a mobile communication terminal), the multimedia data is transmitted to the MS in the packet mode. Otherwise, if the mobile communication system transmits a voice signal to the MS, the voice signal is transmitted to the MS in the circuit mode.

If a user is in motion when the multimedia service is provided from the WCDMA system to the MS, the user who carries the MS may move to another BTS area or other sectors of a current BTS. In this case, it is determined that the MS is handed over from the current BTS to another BTS, or is handed over from one sector area to another sector area in the current BTS. In this manner, the handover technology is a technique for switching a call path between the MS and the BTS to continuously maintain a traffic channel even though the MS leaves a service area of the BTS providing the MS with a communication service.

FIG. 1 is an example of the arrangement of slots of a downlink dedicated physical channel for use in a WCDMA-based IMT-2000 system.

Referring to FIG. 1, the BTS transmits binary data, indicative of power increment/decrement of about 1,500 times per second, to the MS using a TPC (Transmitter Power Control) slot of a downlink dedicated physical channel, i.e., a DPCCH (Dedicated Physical Control Channel).

The MS receives a power control command from the BTS, such that it adjusts a transmission power within a predetermined range of 0.5 dB˜1 dB.

The MS may be operated in two operations modes, i.e., a congestion mode and a normal mode. In more detail, if a power control command received from the BTS is successively generated N times and is indicative of a power increment command, the MS is determined to be in the congestion mode. In this case, provided that the MS is in a soft handover situation during the congestion mode, it successively receives N power increment commands from all. BTSs, each of which currently performs a soft handover. In the meantime, if the MS is in the normal mode, it performs location registration of a BTS and enters an idle mode, such that it receives an incoming call from the BTS.

If the power increment command from the BTS occurs more than N times, the MS searches for a neighboring BTS using a cell scan function. Thereafter, the MS is soft-handed over from the BTS to the neighboring BTS. In more detail, the MS begins the soft handover from an old BTS to a new BTS having the highest reception sensitivity associated with a pilot channel.

The soft handover allows the MS, which moves to a cell boundary between a current cell to a neighboring cell, to set up a radio link having a frequency band equal to that of the neighboring cell in such a way that the MS can establish a plurality of radio links.

The soft handover scheme allows the MS to add a radio link while the MS is in motion, and at the same time allows the MS to set up a plurality of radio links, such that a call drop (also called a call disconnection) and a variation in bit rate are not generated, resulting in the maintenance of service continuity. However, a plurality of channels are assigned to the MS, such that there arises an unnecessary waste of channel resources in the BTS. Furthermore, dedicated channels for the WCDMA system are soft-handed over, resulting in an excessive waste of channel resources.

### DISCLOSURE OF THE INVENTION

Therefore, the present invention has been made in view of the above problems, and it is an object of the present invention to provide a method and system for establishing a handover based on a QoS in a WCDMA system, which determines a handover scheme according to a QoS grade in the WCDMA scheme, and performs a hard handover to a call signal of a low QoS, resulting in minimum waste of channel resources.

In accordance with one aspect of the present invention, the above and other objects can be accomplished by the provision of a handover setup system based on a QoS (Quality of Service) in a WCDMA (Wideband Code Division Multiple Access) system, the handover setup system determining a handover scheme according to a QoS grade, and performs a hard handover for a call signal having a low QoS grade, comprising: a Mobile Station (MS), used for a voice communication service or multimedia service over a CSN (Circuit Switched Network) or a PSN (Packet Switched Network), for determining whether a current QoS grade is low when the MS is handed over from a current cell to a neighboring cell in a call connection state, and receiving a hard handover signal from a Node B in order to perform a hard handover if it is determined that the current QoS grade is low; the Node B for performing a wireless access endpoint function associated with the MS, and transmitting/receiving voice, image, and data to/from the MS according to a WCDMA scheme; and an asynchronous Radio Network Controller (RNC) for recognizing a call connection state of the MS, determining whether a QoS grade of the call connection state is a low-order grade, and assisting a hard handoff to the MS if it is determined that the QoS grade of the call connection state is the low-order grade.

In accordance with another aspect of the present invention, there is provided a handover setup method based on a QoS (Quality of Service) in a WCDMA (Wideband Code Division Multiple Access) system, the method determining a handover scheme according to a QoS grade, and performs a hard handover to a call signal of a low QoS grade, comprising the steps of: a) establishing a call connection state with a Mobile Station (MS) upon receiving a call connection request message from the MS; b) transmitting a measurement control message for a handover to the MS; c) determining the QoS grade, and establishing a new radio link; d) transmitting a radio link setup request message to a destination Node B to which the MS is to be handed over, and establishing a data transport bearer in association with the destination Node B; e) transmitting or receiving a synchronization message for data transmission to/from the destination Node B; f) transmitting an active-set update command message to the MS, and performing the hard handover; and g) transmitting a radio link deletion request message to a source Node B, and canceling a data transport bearer between the source Node B and the destination Node B.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an example of the arrangement of slots of a downlink dedicated physical channel for use in a WCDMA-based IMT-2000 system;

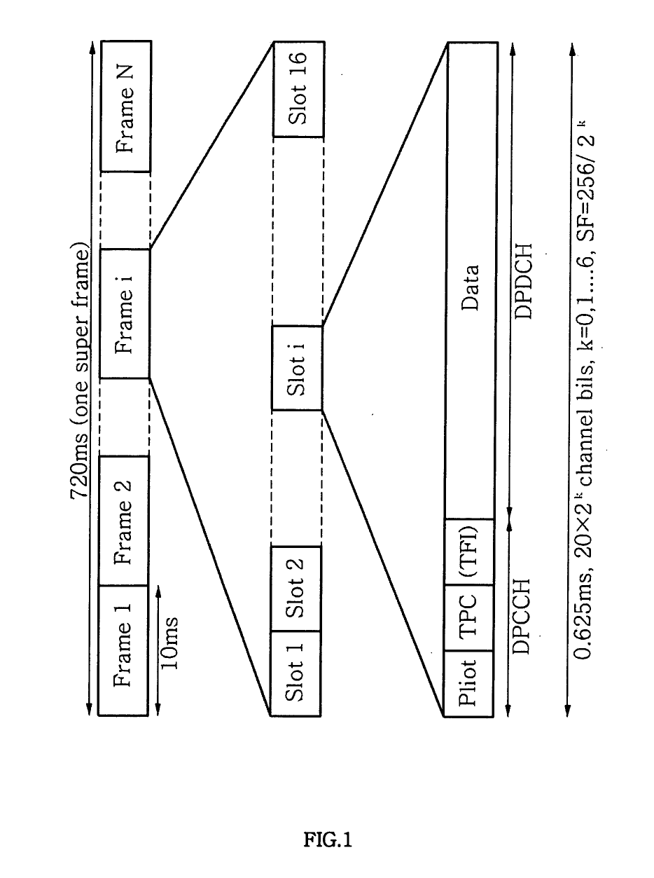

FIG. 2 is a block diagram illustrating a WCDMA system for establishing a handover based on a QoS in accordance with a preferred embodiment of the present invention;

FIG. 3 is a block diagram illustrating an internal configuration of a mobile station (MS) in accordance with a preferred embodiment of the present invention; and

FIG. 4 is a flow chart illustrating a handover setup process based on a QoS in a WCDMA system in accordance with a preferred embodiment of the present invention.

### BEST MODE FOR CARRYING OUT THE INVENTION

Now, preferred embodiments of the present invention will be described in detail with reference to the annexed drawings. In the drawings, the same or similar elements are denoted by the same reference numerals even though they are depicted in different drawings. In the following description, a detailed description of known functions and configurations incorporated herein will be omitted when it may make the subject matter of the present invention rather unclear.

QoS classes for a WCDMA network are classified into a conversation class, a streaming class, an interactive class, and a background class.

The conversation class is used in transmission of real-time data such as in a voice communication or video communication, and is indicative of a service class having very weak resistance to transfer delay. The streaming class is indicative of a real-time traffic transmission service for transmitting data such as moving image data in the form of streaming data, and is less sensitive to the transfer delay than the conversation class even though it is sensitive to the transfer delay. The interactive class is indicative of an interactive application service such as WWW (World Wide Web) or Telnet. Lastly, the background class may be services such as an E-mail transmission and a file download, etc.

The interactive class and the background class are mainly used for Internet applications, and are less sensitive to the transfer delay than the conversation class or the streaming class. Therefore, if a retransmission technique is applied to the interactive class and the background class, the interactive class and the background class can greatly minimize the number of transmission errors as compared to the conversation class or the streaming class.

The present invention can define the following parameters associated with a QoS on the basis of the aforementioned traffic service categories.

1) Maximum Bit Rate: The maximum number of deliverable bits;

2) Guaranteed Bit Rate: The number of bits whose delivery need be guaranteed;

3) Delivery Order: Parameter indicating whether a packet must be sequentially transmitted or a packet acceptable even though it is non-sequentially transmitted;

4) Maximum Service Data Unit (SDU) Size: Allowable Maximum SDU Size;

5) SDU Format Information: Available list of SDU sizes;

6) SDU Error Ratio: Error generation ratio of SDU;

7) Residual Bit Error Ratio: Undetected Bit Error Ratio in individual subflows contained in a transmitted SDU;

8) Delivery of Erroneous SDUs: Parameter for determining whether SDU detected by errors is transmitted;

9) Transfer Delay: Parameter indicative of delay of all transmission SDUs while a bearer service is provided; and

10) Traffic Handling Priority: Priority used when traffic is scheduled.

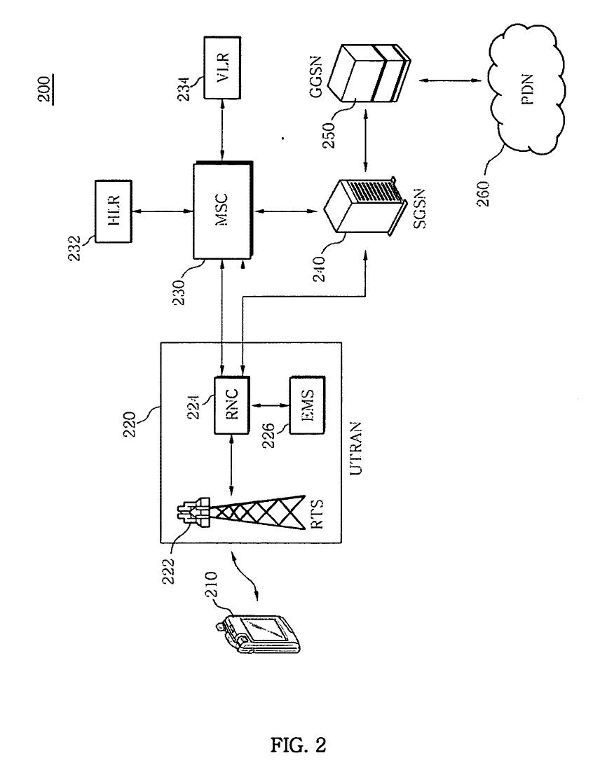

FIG. 2 is a block diagram illustrating a WCDMA system for establishing a handover based on a QoS in accordance with a preferred embodiment of the present invention.

Referring to FIG. 2, the WCDMA system includes an MS 210, a UTRAN (UMTS Terrestrial Radio Access Network) 220, an MSC (Mobile Switching Center) 230, an HLR (Home Location Register) 232, a VLR (Visitor Location Register) 234, an SGSN (Serving GPRS Support Node) 240, a GGSN (Gateway GPRS Support Register) 250, and a PDN (Packet Data Network) 260.

In accordance with the present invention, if the MS 210 is handed over from a current cell to a neighboring cell while maintaining a call connection state, it receives a hard handover signal from the UTRAN 220 when a QoS grade is low such that it performs a hard handover. The present invention may use a variety of MSs, for example, mobile phones and PDAs (Personal Digital Assistants), etc.

The UTRAN 220 includes a Node B 222 including an additional function to support WCDMA in-a conventional IS-95B system, and a Radio Network Controller (RNC) 224. The Node B 222 performs a wireless access endpoint function associated with the MS 210 based on a 3GPP wireless access protocol, transmits/receives voices, images, and data traffic according to the WCDMA scheme, and communicates with the MS 210 over a transmission/reception antenna. An internal subsystem of the Node B 222 includes a BIS (Basestation Interconnection Subsystem), a BBS (Base Band Subsystem), and an RF (Radio Frequency) Subsystem.

The RNC 224 performs a variety of functions, for example, a wired/wireless channel management function, an MS 210 protocol interconnection function, a UTRAN protocol interconnection function, a soft-handoff processing function, a CN (Core Network) protocol processing function, a GPRS (General Packet Radio Service) access function, a call failure management function, and a system loading function, etc. In this case, the GPRS is indicative of an asynchronous communication service, which supports, a data transfer rate of 115 kbps, provides multimedia mail, and transmits data in packet units, resulting in maximum efficiency of a transfer link.

An EMS (Element Management System) 226 is required when an operator directly installs a variety of parameters for mobile communication in an object device or manages such parameters. In accordance with the present invention, the operator sets a hard handover or a soft handover according to a QoS grade in the EMS 226.

The MSC 230 includes not only a basic switching function required for a phone call over a typical CDMA (Code Division Multiple Access) 2000 network, but also a soft switching configuration for a high-speed call control process. In this case, the soft switching refers to a technique in which a circuit switch of a conventional switching system is implemented in the form of a software switch such that voice, data, and video signals can be processed by a high-speed packet switch.

The HLR 232 receives location information of the MS 210 from the VLR 234, and performs a variety of functions, for example, a registration recognition function, a registration deletion function, and a location acknowledgement function, etc. The HLR 232 retrieves profile information of the MS 210 from an initial HLR in which the MS 210 has been initially registered, by using the location information received from the VLR 234. The HLR 232 checks a connection state of the MS 210 whose location has been registered in the HLR 232, such that it determines whether the MS 210 is in either an idle mode or an active mode. If the MS 210 is in the active mode, the HLR 232 continuously monitors whether the MS 210 is connected to a circuit switched network (CSN) or a packet switched network (PSN).

The VLR 234 registers the MS 210's location information received in a coverage area of the MSC 230, manages the registered location information of the MS 210, and informs the HLR 232 of the newly-registered location information of the MS 210. The VLR 234 receives a copy of the MS 210's profile information from the HLR 232, and manages the copied profile information of the MS 210, such that it can properly apply the copied profile information of the MS 210 to a variety of functions, for example, a location control function, and a call control function, etc. Although FIG. 2 depicts the VLR 234 separately installed to the outside of the MSC 230 for the convenience of description, it should be noted that the VLR 234 is generally installed in the MSC 230.

The SGSN 240 includes a hardware structure for providing an ATM (Asynchronous Transfer Mode)—based switch and a routing access service in order to achieve a GPRS service, and an OS (Operating System) for processing a variety of data services. The OS performs a variety of principal functions, for example, a GPRS mobility management function, a GPRS session management function, a GPRS authentication function, and a charging function, etc. The GGSN 250 of a serving node for use in an IP (Internet Protocol)—based packet network, which provides a high-speed packet data service for a GPRS data service. The GGSN 250 is connected to the PDN 260, such that it provides mobility of a packet data service, and performs a protocol processing function associated with various data. The GGSN 250 performs a variety of functions, for example, an address assignment function, a domain address change function, an account data processing function, and maintenance function

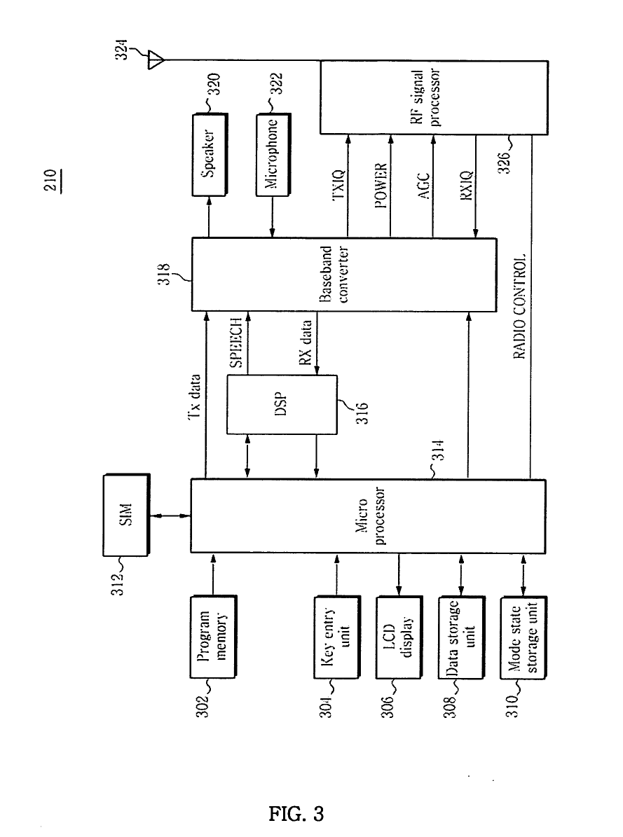

FIG. 3 is a block diagram illustrating an internal configuration of the MS 210 in accordance with a preferred embodiment of the present invention.

Referring to FIG. 3, the MS 210 includes a program memory 302, a key entry unit 304, an LCD display 306, a data storage unit 308, a mode state storage unit 310, an SIM (Subscriber Identity Module) 312, a microprocessor 314, a DSP (Digital Signal Processor) 316, a baseband converter 318, a speaker 320, a microphone 322, an antenna 324, and an RF signal processor 326, etc.

The program memory 302 performs a plain wireless phone call over a mobile communication network, and stores a communication protocol software program for processing transmission/reception data according to a prescribed protocol. Particularly, upon receiving a handover-associated message from the UTRAN 220, the MS 210 stores a predetermined program for selectively performing a soft handover or a hard handover to the UTRAN 220.

The key entry unit 304 includes a plurality of number buttons for entering desired number data such as a phone number, and menu buttons for selecting a desired menu or entering a desired command.

The LCD display 306 displays remaining power of the power-supply, propagation reception intensity, and day and time information, and also displays overall operation states of the MS 210.

The data storage unit 308 acts as a buffer of data transmitted/received via the microprocessor 314 when the MS 210 is in operation, stores data received from an external part, and stores data (i.e., number data) received from the key entry unit 304.

The mode state storage unit 310 stores an operation mode of the MS 210 as a state flag. In this case, the operation mode is selected by the key entry unit 304. The SIM 312 stores subscriber station registration information for mobile phone communication. In this case, the subscriber station registration information is a unique number assigned for each subscriber station in a mobile communication network. The subscriber information storage unit 312 is configured in the form of a card, such that it is inserted in the MS 210.

The microprocessor 314 controls operations of the MS by referring to the state flag stored in the mode state storage unit 310. Particularly, the microprocessor 314 stores data received from an external device in the data storage unit 308, or outputs the received data to the LCD display 306, such that the LCD display 308 displays the received data. In this case, if a user transmits data to another MS or another external device, the microprocessor 314 transmits the data (i.e., Tx data) to the baseband converter 318, such that the data is converted into a signal format used in a mobile communication network.

The DSP 316 or a digital signal processor performs an audio data processing function for encoding or decoding audio or speech data transmitted/received to/from the baseband converter 318, and also performs an equalizer function to remove multipath noise. The DSP 316 receives received message data (i.e., Rx data) from the baseband converter 318.

The baseband converter 318 converts a signal transmitted/received to/from the speaker 320, the microphone 322, and the RF signal processor 326 into a baseband signal, and performs a DAC (Digital-to-Analog Conversion) process or an ADC (Analog-to-Digital Conversion) process. Therefore, the baseband converter 318 converts the audio data received from the DSP 316 into an audio signal, such that it outputs the audio signal to the speaker 320 or transmits the audio data to the RF signal processor 326 for data transmission. Also, the baseband converter 318 converts the audio signal received from the microphone 322 into audio data, and transmits the audio data to the DSP 316.

The baseband converter 318 receives transmission message data (i.e., Tx data) from the microprocessor 314, converts the received Tx data into a transmission message signal denoted by TXIQ, and outputs the TXIQ signal to the RF signal processor 326. The baseband converter 318 receives a received message signal denoted by RXIQ from the RF signal processor 326, converts the RXIQ signal into received message data (i.e., Rx data), and outputs the Rx data to the DSP 316.

The speaker 320 generates the audio signal. The microphone 322 converts a voice or acoustic signal of a user into an audio signal, and transmits the audio signal to the baseband converter 318.

The antenna 324 wirelessly transmits an RBF signal to an air interface, or transmits the RF signal received from the air interface to the RF signal processor 326. The RF signal processor 326 converts the TXIQ signal into the RF signal, and transmits the RF signal to the antenna 324. The RF signal processor 326 converts the RF signal received via the antenna 324 into the RXIQ signal, and transmits the RXIQ signal to the baseband converter 318.

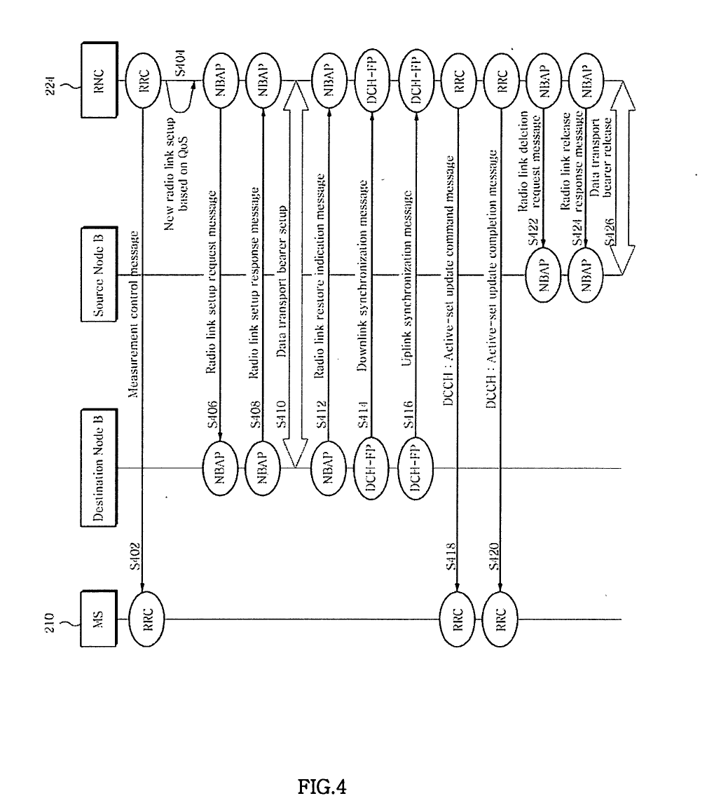

Preferred operations of the aforementioned WCDMA system 200 will hereinafter be described with reference to FIG. 4.

FIG. 4 is a flow chart illustrating a handover setup process based on a QoS in the WCDMA system in accordance with a preferred embodiment of the present invention.

The relationship between QoS-associated characteristics for use in the WCDMA network and QoS grades will be described with reference to Table 1. Table 1 depicts relationship between QoS-associated parameters and a traffic class.

TABLE 1

| | Conversation | Streaming | Interactive | Background |
|---|---|---|---|---|
| Categories | Class | Class | Class | Class |
| Maximum Bit | X | X | X | X |
| Rate | | | | |
| Delivery | X | X | X | X |
| Order | | | | |
| Maximum SDU | X | X | X | X |
| Size | | | | |
| SDU Format | X | X | | |
| Information | | | | |
| SDU Error | X | X | X | X |
| Ratio | | | | |
| Residual | X | X | X | X |
| Bit Error | | | | |
| Ratio | | | | |
| Delivery of | X | X | X | X |
| Erroneous | | | | |
| SDUs | | | | |
| Transfer | X | X | | |
| Delay | | | | |
| Guaranteed | X | X | | |
| Bit Rate | | | | |
| Traffic | | | X | |
| Handling | | | | |
| Priority | | | | |

With reference to Table 1, the conversation class and the streaming class use all the parameters other than parameters associated with traffic handling priority. The interactive class uses all the parameters other than parameters associated with the SDU format information, the transfer delay, and the guaranteed bit rate. The background class uses parameters, which are associated with the maximum bit rate, the delivery order, the maximum SDU size, the SDU error ratio, the residual bit error ratio, and the delivery or erroneous SDUs.

Table 2 depicts QoS grades determined by the traffic handling priority based on QoS grades and QoS parameters.

TABLE 2

| QoS Grade | Traffic Class | Traffic Handling Priority |
|---|---|---|
| 1 | Interactive | 1 |
| | Class | |
| 2 | Conversation | Not Applied |
| | Class | |
| 3 | Streaming Class | Not Applied |
| 4 | Interactive | 2 |
| | Class | |
| 5 | Interactive | 3 |
| | Class | |
| 6 | Background | Not Applied |
| | Class | |

In this case, a service having a low QoS grade is not greatly affected by an overall QoS even though a slight transfer delay or a reduction of a bit rate occurs. Therefore, the present invention is designed to perform a hard handover to services having fourth to sixth grades corresponding to low QoS grades.

Firstly, the MS 210 requests a call connection service from the UTRAN 220, such that a call connection state between the MS 210 and one of a called MS and a wireless Internet server is established.

Therefore, the MS 210 establishes a phone call with the called MS, or wirelessly communicates with the wireless Internet server.

If the MS 210 moves from a cell of a source Node B managing a current position of the MS 210 to a cell of a neighboring destination Node B, the RNC 224 transmits a measurement control message for performing a handover to the MS 210 at step S402.

The RNC 224 determines a QoS grade by recognizing a call connection state, and establishes a new radio link according to the determined QoS grade at step S404. For example, if the MS 210 performs the conversation class service for establishing a call connection state with the called party, the RNC 224 determines a current QoS grade of the MS 210 to be the second grade, such that it establishes a soft handover. However, if the MS 210 performs the background class service for receiving an E-mail from the wireless Internet server, the RNC 224 determines a QoS grade of the MS 210 to be the sixth grade, such that it establishes a hard handover.

A method for performing the hard handover when the MS 210 performs services of the fourth to sixth grades indicative of low QoS grades will be described with reference to FIG. 4.

The RNC 224 transmits a radio link setup request message to a destination Node B using an NBAP (Node B. Application Protocol) for performing a call control process between Node Bs at step S406.

Upon receipt of the radio link setup request message, destination Node B transmits a radio link setup response message to the RNC 224 using the NBAP in the same manner as in the RNC 224 at step S408.

Upon receipt of the radio link setup response message, the RNC 224 transmits a data transport bearer setup message to destination Node B, such that it establishes a data transport bearer in association with destination Node B at step 410.

If the data transport bearer between the RNC 224 and destination Node B has been established, destination Node B transmits a radio link restore indication message to the RNC 224, such that it informs the RNC 224 of a radio link setup situation at step S412.

Thereafter, the RNC 224 transmits a downlink synchronization message for synchronization of data transmission to destination Node B using a DCH-FP (Data CHannel—Frame Protocol) for data frame transmission at step S414.

Upon receipt of the downlink synchronization message, destination Node B transmits an uplink synchronization message to the RNC 224 at step S416.

Thereafter, the RNC 224 transmits an active-set update command message for performing a handover to the MS 210 over a DCCH (Dedicated Control CHannel) using an RRC (Radio Resource Control) protocol at step 418.

Upon receiving the active-set update command message from the RNC 224, the MS 210 performs a handover, and transmits an active-set update completion message to the RNC 224 at step S420.

Upon receiving the active-set update completion message from the MS 210, the RNC 224 transmits a radio link deletion request message to source Node B using the NBAP at step S422.

Upon receipt of the radio link deletion request message, source Node B interrupts data transmission/reception toward the RNC 224, and transmits a radio link release response message to the RNC 224 at step S424.

Therefore, the data transport bearer between the RNC 224 and source Node B is cancelled at step S426.

In accordance with a preferred embodiment of the present invention, the present invention provides a method and system for establishing a handover based on a QoS of a WCDMA system, which performs a hard handover to an MS call signal of a low QoS grade in the WCDMA system, resulting in minimum waste of channel resources.

### INDUSTRIAL APPLICABILITY

As apparent from the above description, the present invention performs a hard handover to a bearer of a low QoS grade, resulting in minimum waste of channel resources.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A handover setup system based on a QoS (Quality of Service) in a WCDMA (Wideband Code Division Multiple Access) system, the handover setup system determining a handover scheme according to a QoS grade, and performs a hard handover for a call signal having a low QoS grade, comprising:
a Mobile Station (MS), used for a voice communication service or multimedia service over a CSN (Circuit Switched Network) or a PSN (Packet Switched Network), for determining whether a current QoS grade is low when the MS is handed over from a current cell to a neighboring cell in a call connection state, and receiving a hard handover signal from a Node B in order to perform a hard handover if it is determined that the current QoS grade is low;
the Node B for performing a wireless access endpoint function associated with the MS, and transmitting/receiving voice, image, and data to/from the MS according to a WCDMA scheme; and
an asynchronous Radio Network Controller (RNC) for recognizing a call connection state of the MS, determining whether a QoS grade of the call connection state is a low-order grade, and assisting a hard handoff to the MS if it is determined that the QoS grade of the call connection state is the low-order grade.

2. The handover setup system according to claim 1, wherein the MS receives the multimedia service over an asynchronous WCDMA network acting as the PSN, and performs the voice communication service over an IS-95B (Interim Standard—95B) network acting as the CSN.

3. The handover setup system according to claim 1, wherein the MS is a Hybrid Access Terminal (HAT) for supporting both an IS-95 system and the WCDMA system.

4. The handover setup system according to claim 1, wherein the WCDMA system includes:
a Mobile Switching Center (MSC) for transmitting/receiving the phone call service and the multimedia service, and performing a soft switching function for a high-speed call control process;
a Home Location Register (HLR) for receiving location information of the MS, and performing a registration recognition function, a registration deletion function, and a location acknowledgement function;
a Visitor Location Register (VLR) for registering the MS's location information received in a coverage area of the MSC, managing the registered location information of the MS, and informing the HLR of the newly-registered location information of the MS;
a Serving GPRS Support Node (SGSN) including a hardware structure for providing an ATM (Asynchronous Transfer Mode)—based switch and a routing access service in order to achieve a GPRS (General Packet Radio Service) service, and also including an OS (Operating System) for processing a data service;
a Gateway GPRS Support Node (GGSN) for transmitting a high-speed packet data service for the data service to the PSN, providing mobility of the data service, and performing a protocol associated with various data; and
an Element Management System (EMS) for enabling an operator to set a variety of parameters for communication or to manage the parameters, and establishing the hard handover or a soft handover according to a QoS grade.

5. The handover setup system according to claim 1, wherein the RNC performs a wired/wireless channel management function, a protocol interconnection function of the MS, a protocol interconnection function of the Node B, a soft handoff process, a CN (Core Network) protocol process, a GPRS (General Packet Radio Service) access function, a call failure management function, and a system loading function.

6. The handover setup system according to claim 1, wherein the QoS grade includes:
a conversation class indicative of a real-time traffic transmission service including a voice phone or video phone service;
a streaming class indicative of a real-time traffic transmission service capable of providing data in the form of streaming data;
an interactive class indicative of an interactive application service including WWW (World Wide Web) or Telnet; and
a background class indicative of a service including an E-mail transmission service or a downloading service.

7. The handover setup system according to claim 6, wherein the interactive class having the highest traffic handling priority is determined to be a first grade, the conversation class is determined to be a second grade, the streaming class is determined to be a third grade, the interactive class is determined to be fourth and fifth grades, and then the background class is determined to be a sixth grade, such that the fourth to sixth grades indicative of low QoS grades are processed by a hard handoff.

8. A handover setup method based on a QoS (Quality of Service) in a WCDMA (Wideband Code Division Multiple Access) system, the method determining a handover scheme according to a QoS grade, and performs a hard handover to a call signal of a low QoS grade, comprising the steps of:
a) establishing a call connection state with a Mobile Station (MS) upon receiving a call connection request message from the MS;
b) transmitting a measurement control message for a handover to the MS;
c) determining the QoS grade, and establishing a new radio link;
d) transmitting a radio link setup request message to a destination Node B to which the MS is to be handed over, and establishing a data transport bearer in association with the destination Node B;
e) transmitting or receiving a synchronization message for data transmission to/from the destination Node B;
f)transmitting an active-set update command message to the MS, and performing the hard handover; and
g) transmitting a radio link deletion request message to a source Node B, and canceling a data transport bearer between the source Node B and the destination Node B.

9. The handover setup method according to claim 8, wherein the new radio link at step (c) is indicative of a radio link, which performs the hard handover when the QoS grade is low, or performs a soft handover when the QoS grade is high.

10. The handover setup method according to claim 8, wherein step (d) includes the step of:
establishing the data transport bearer upon receiving the radio link setup request message from the destination Node B.

11. The handover setup method according to claim 8, wherein step (e) includes the step of:
upon receiving a radio link restore indication message indicating that the data transport bearer has been established from the destination Node B, transmitting a downlink synchronization message to the destination Node B using a DCH-FP (Data CHannel—Frame Protocol) for data transmission, and receiving an uplink synchronization message from the destination Node B.

12. The handover setup method according to claim 8, wherein step (f) includes the step of:
performing, by the MS, the hard handover upon receiving the active-setup update command message from a Radio Network Controller (RNC), and transmitting an active-set update completion message, indicating that the hard handover has been performed, to the RNC.

13. The handover setup method according to claim 8, wherein step (g) includes the step of:
canceling the data transport bearer upon receiving a radio link release response message from the MS.

14. The handover setup method according to claim 8, wherein the MS receives a multimedia service over an asynchronous WCDMA network acting as a PSN (Packet Switched Network, and performs a phone call service over an IS-95B (Interim Standard—95B) network acting as a CSN (Circuit Switched Network).

15. The handover setup method according to claim 8, wherein the QoS grade includes:
a conversation class indicative of a real-time traffic transmission service including a voice phone or video phone service;
a streaming class indicative of a real-time traffic transmission service capable of providing data in the form of streaming data;
an interactive class indicative of an interactive application service including WWW (World Wide Web) or Telnet; and
a background class indicative of a service including an E-mail transmission service or a downloading service.

16. The handover setup method according to claim 15, wherein the interactive class having the highest traffic handling priority is determined to be a first grade, the conversation class is determined to be a second grade, the streaming class is determined to be a third grade, the interactive class is determined to be fourth and fifth grades, and then the background class is determined to be a sixth grade, such that the fourth to sixth grades indicative of low QoS grades are processed by a hard handoff.
